(19) United States
(12) Patent Application Publication
(10) Pub. No.: US 2004/0260618 A1
(43) Pub. Date: Dec. 23, 2004

(54) Home shopping system

(76) Inventor: Damon Larson, Fargo, ND (US)

Correspondence Address: INTELLECTUAL PROPERTY GROUP, FREDRIKSON & BYRON, P.A., 200 SOUTH SIXTH STREET, SUITE 4000, MINNEAPOLIS, MN, 55402, US

(21) Appl. No.: 10/600,994

(22) Filed: Jun. 19, 2003

(51) Int. Cl. G06F 17/60

(52) U.S. Cl. 705/26

(57) ABSTRACT

The inventive system allows a consumer to scan product tags and have the scanned information transferred to a website via a network, where the consumer can either manually or automatically transfer the information therefrom to one or more desired retailer network sites.

### TECHNICAL FIELD

The invention relates to a system for at-home shopping, and in particular, for at-home shopping using scanned product information that is subsequently transferred over a network.

### BACKGROUND OF THE INVENTION

There are a number of existing ways for consumers to shop from their homes. Some older, more antiquated methods involve mail-order shopping via catalogs. These methods require the consumer to initially acquire and review a retailer's catalog, mark the products he or she wants to purchase on a mail-order form, and subsequently send the form to the retailer. In response, the retailer would send the ordered products to the consumer through the mail. Payment from the consumer for the products would either be requested upfront, or would be required POD (payment on delivery). Another method of shopping still widely used today is through television. Whether through commercials or shopping networks broadcast on the television networks, products are showcased to viewing consumers. During such broadcasts, the consumers are often urged to call by phone, typically via toll-free numbers, to place their order for the products showcased, after which, the products are commonly sent to the consumer and paid for as described above.

One method of shopping that has rapidly increased in popularity over the past decade is through the Internet. Retailers have come to appreciate the large percentage of the population that uses the Internet each day, whether for business-related or personal reasons. As a result, the majority of retailers have designed websites on the Internet that consumers can visit and browse. Quite often, the websites would be designed for use in combination with or instead of the retail catalogs, with product lines being showcased thereon. In addition, the option is often given to the consumer to call the retailer for ordering. Even more common is the option to place an order online. This type of online shopping from the retailer usually involves the consumer registering with the retailer, typically by entering personal information (i.e., name, address) as well as credit card information. When the registration is completed, the consumer can select the products he or she is interested in buying. In turn, the products are sent to the consumer through the mail.

While the method of online shopping has rapidly improved the efficiency by which consumers can now shop, there are still disadvantages. One disadvantage is that the consumer must typically visit one or more websites on the Internet before finding products that are desired. Additionally, the consumer usually needs to familiarize himself with the products before ordering online in order to ensure that what he or she orders online is truly that which is desired. Finally, the consumer generally has to scroll through the products on each particular website to locate the one or more products that he or she may be interested in ordering. It is an intention of this invention to provide an online shopping system that avoids these disadvantages as well as others that will become apparent herein.

### SUMMARY OF THE INVENTION

The inventive system allows a consumer to scan product tags and have the scanned information transferred to a website via a network, where the consumer can either manually or automatically transfer the information therefrom to one or more desired retailer network sites.

Certain embodiments of the invention provide a shopping system. The system comprises a scanner adapted to scan one or more product tags. Also included is a processing device accessible to a network, in which the processing device is operatively coupled to the scanner. Additionally, a client application is installed on the processing device, in which the client application is adapted to read scanned data from the scanner and to transfer the data over the network. Further, a server on the network is adapted to receive the transferred data. Finally, a server application configured to run on the server is included, in which the server application is adapted to route the transferred data to one or more retailer network sites.

Another embodiment of the invention includes a home shopping system. The system comprises a means for reading and storing one or more product tags. Also included is a processing device accessible to a network, in which the processing device is operatively coupled to the means. Additionally, a client application is installed on the processing device, in which the client application is adapted to read the stored data and to transfer the data over the network. Further, a server on the network is adapted to receive the transferred data. Finally, a server application configured to run on the server is included, in which the server application is adapted to route the transferred data to one or more retailer network sites.

One other embodiment of the invention includes a home shopping system. The system comprises a means for reading and storing one or more product tags, in which the means is accessible to a network. Additionally, a client application is installed on the means, in which the client application is adapted to read the stored data and to transfer the data over the network. Further, a server on the network is adapted to receive the transferred data. Finally, a server application configured to run on the server is included, in which the server application is adapted to route the transferred data to one or more retailer network sites.

Further, certain embodiments of the invention provide a method of shopping. The method comprises scanning one or more product tags using a scanner. Additionally, the method comprises coupling the scanner to a processing device accessible to a network. Further, the method comprises transferring the scanned data to a server over the network using a client application. Finally, the method comprises transferring the scanned data to one or more retailer network sites from the server using a server application.

### BRIEF DESCRIPTION OF THE DRAWINGS

FIG. 1 is a flowchart showing steps for utilizing the home shopping system in accordance with certain embodiments of the invention;

FIG. 2 is a front view of a computer screen shot illustrating downloadable client software via the Internet in accordance with certain embodiments of the invention;

FIG. 3 is a front view of a computer screen shot illustrating a manual launch option for client software in accordance with certain embodiments of the invention;

FIG. 4 is a front view of a computer screen shot illustrating certain tasks completed by client software subsequent to its launch in accordance with certain embodiments of the invention;

FIG. 5 is a flowchart showing tasks performed by client software subsequent to its launch in step 115 of the flowchart of FIG. 1;

FIG. 6 is a flowchart showing tasks performed by server software subsequent to receiving scanned data in step 120 of the flowchart of FIG. 1;

FIG. 7 is a front view of a computer screen shot illustrating a message from client software regarding a successful transfer of scanned data in accordance with certain embodiments of the invention;

FIG. 8 is a front view of a computer screen shot illustrating a log-in page to a web server which scanned data is transferred to in accordance with certain embodiments of the invention;

FIG. 9 is a front view of a computer screen shot illustrating a listing of scanned data that was transferred to a web server in accordance with certain embodiments of the invention;

FIG. 10 is a front view of a computer screen shot illustrating selected products being transferred from a web server to a website of a retailer in accordance with certain embodiments of the invention;

FIG. 11 is a block diagram illustrating elements utilized in transferring scanned data from a web server to a pair of eRetailer network sites in accordance with certain embodiments of the invention;

FIG. 12 is a front view of a computer screen shot illustrating a status report of products transferred successfully and unsuccessfully from a web server to a website of a retailer in accordance with certain embodiments of the invention; and

FIG. 13 is a front view of a computer screen shot illustrating a website of a retailer that includes a listing of products that were successfully transferred from a web server in accordance with certain embodiments of the invention.

### DETAILED DESCRIPTION OF THE INVENTION

The following detailed description is to be read with reference to the drawings, in which like elements in different figures have like reference numerals. The drawings, which are not necessarily to scale, may depict selected embodiments, but are not intended to limit the scope of the invention. It will be understood that many of the specific details of the invention incorporating the system illustrated by the drawings could be changed or modified by one of ordinary skill in the art without departing significantly from the spirit of the invention. The system of the invention is designed for use between consumers and retailers, however it may also be used between other parties, e.g., retailers and distributors, distributors and manufacturers, manufacturers and suppliers, and the like.

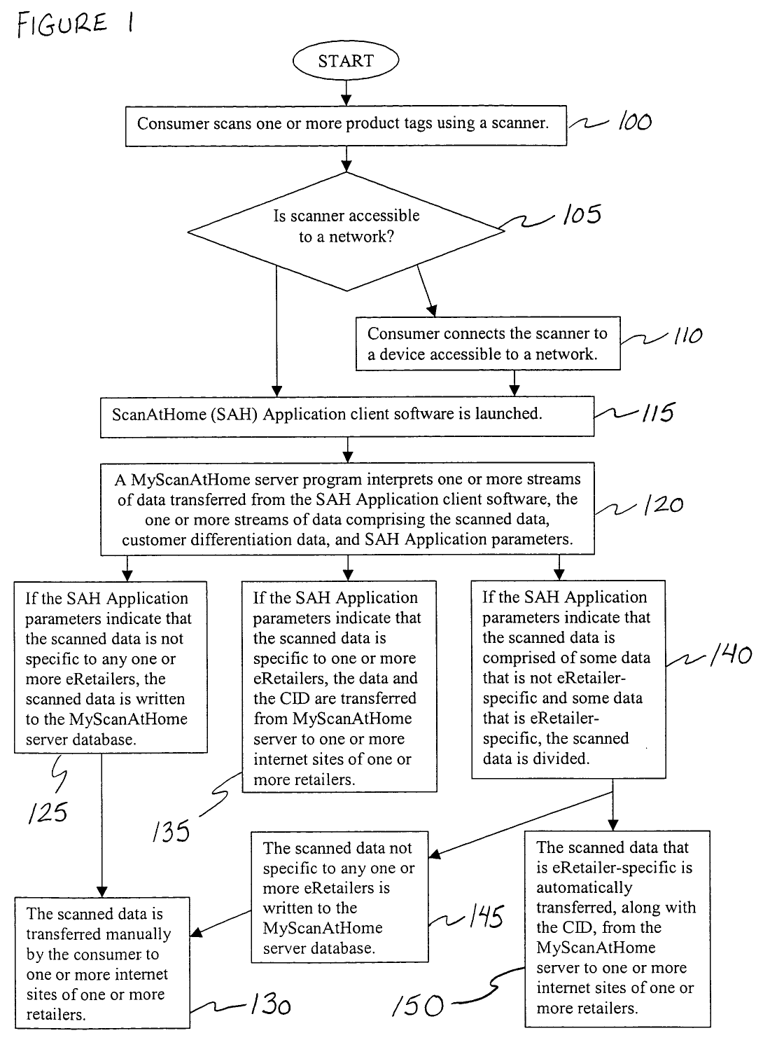

FIG. 1 is a flow chart showing steps for utilizing the home shopping system in accordance with certain embodiments of the invention. The process is initiated in step 100 by a consumer scanning one or more product tags using a scanner. In certain preferable embodiments, each of the product tags is a barcode; however, it is contemplated that each of the tags may instead comprise any kind of coded or non-coded character or value set. It is further contemplated that the tags may be comprised of one or more different character or value sets. The scanner is preferably a laser scanner; however it is appreciated that the scanner may comprise any kind of reader for coded or non coded character or value sets. For example, the scanner could comprise an OCR (optical character recognition) reader. The scanner is preferably a wireless and handheld mechanism, and is generally kept in a downloading cradle when not in use. However, it is appreciated that the scanner may instead be wired to a processing device that is used, for example, to store, to interpret, or to transfer the scanned information from the scanner. The product tags that are typically scanned are located on commercial products.

Normally, as a consumer finishes products at home, for example, cartons of milk or boxes of laundry detergent, and the products need replacing, the consumer often adds the products to a shopping list for use when the consumer next visits a store that sells the products. In contrast, using the invention, the consumer scans the product tag on each of the products with the scanner before disposing of the empty product containers. Preferably, the product tag is typically printed on the label of the product container. Alternatively, one or more of the product tags could be located within product catalogs. As such, the consumer would flip through one of the catalogs and scan the tags of products that need replacing. Once scanned, the product information encoded by the tag would inversely be decoded and held within memory of the scanner.

In certain preferable embodiments of the invention, the scanner would have at least a capability of decoding UCC industry standard barcodes such as UPC/EAN/JAN, Code 128, Code 39, Coupon Code, I 2 of 5, Discrete 2 of 5, as well as customized and eRetailer-specific barcodes. However, as mentioned above, it is contemplated that the scanner could be designed to read any kind of coded or non-coded character or value set. As such, it is contemplated that whatever the scanner is designed to read, it follows that the scanner may further be made to decode the same. The scanner is preferably utilized in the consumer's home; however, it could be carried and subsequently used outside the consumer's home as well. One suitable type of scanner is commercially available from Symbol Technologies (New York, N.Y., U.S.A.).

In step 110, the consumer typically connects the scanner to a processing device accessible to a network. In preferable embodiments of the invention, the processing device would comprise a personal computer (PC); however, the processing device could alternatively comprise a cell phone, a personal digital assistant (e.g., a palm pilot), or the like. The scanner is connected to a processing device via cable, such as USB, serial cable, or other physical cable. However, if the scanner and processing device are configured for wireless communication therebetween, infrared, RF (Radio Frequency), BlueTooth technology, or the like would be utilized. In certain embodiments, it is contemplated that the scanner may already be operatively connected to a network-accessible device. In turn, there would be no need for the customer to make any connection between the scanner and the processing device in order to gain network accessibility. Additionally, the scanner may itself be a processing device configured with network accessibility. As such, there would be no need for the customer to make any connection to an additional device having such access to a network. Therefore, an initial inquiry as to whether the scanner is already accessible to a network is represented in step 105 in order to determine whether an additional connection to the scanner needs to be made, as referenced in step 110.

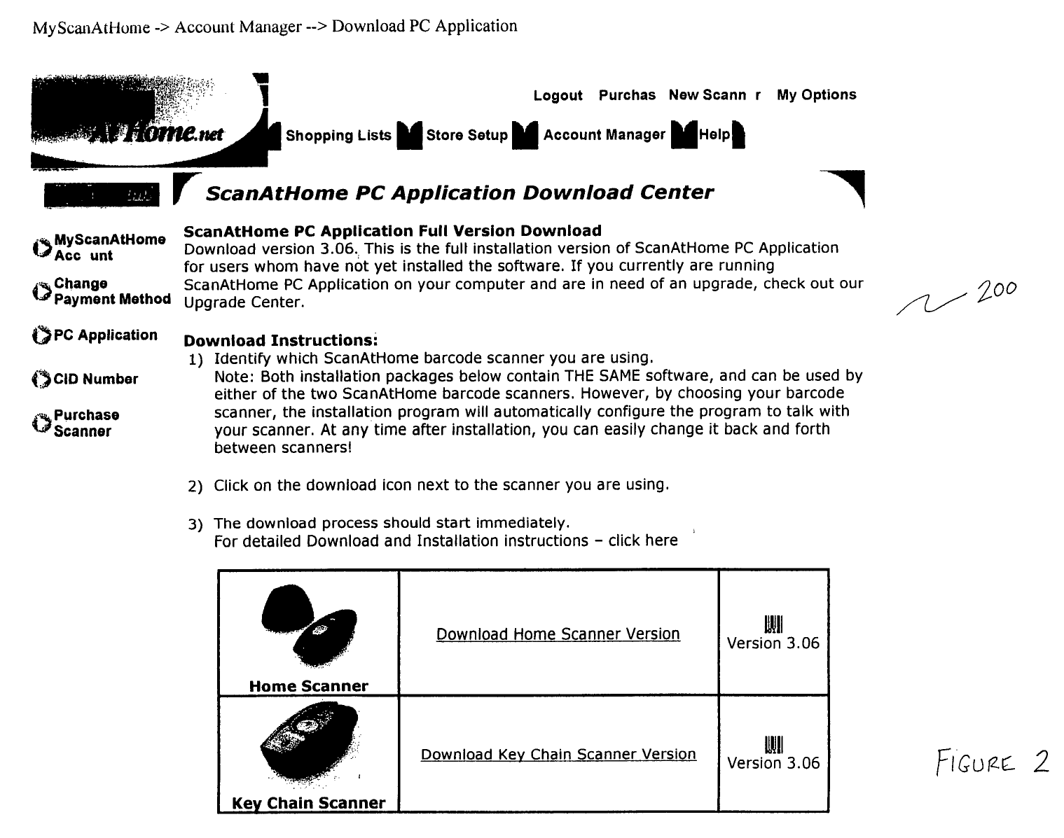

As soon as the scanner is ready for data transfer over the network, a client application is launched in step 115. In certain preferable embodiments, the client application comprises ScanAtHome (SAH) Application software that is commercially available from GYG Technologies Inc., (Fargo, N. Dak., U.S.A.). The client software is generally installed on the processing device accessible to the network, e.g., the PC. Additionally, the software is preferably used with operating systems such as Windows 95/98, Windows NT/2000, Windows ME/XP, Windows CE, and Windows Pocket PC, and can be downloaded over the Internet (see screen shot 200 shown in FIG. 2) or can be installed via CD-ROM. Typically installed with a standard protective program, which is also commercially available from GYG Technologies Inc., under the tradename InstallShield™, the client software must be unlockcd through customer differentiation data during the time of installation. In certain preferable embodiments, the customer differentiation data would comprise a unique Customer Identification Number (CID). Once entered, the CID is usually stored locally on the processing device, typically in the registry. Upon its launch, the client application is configured to automatically look for the scanning device it last communicated with; however, the software can be modified so that other scanning devices may be used as well.

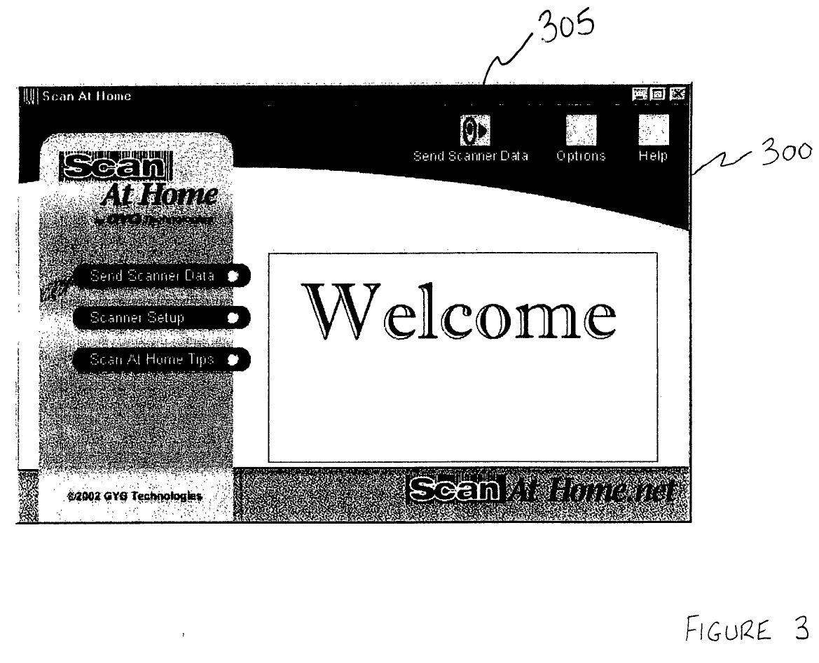

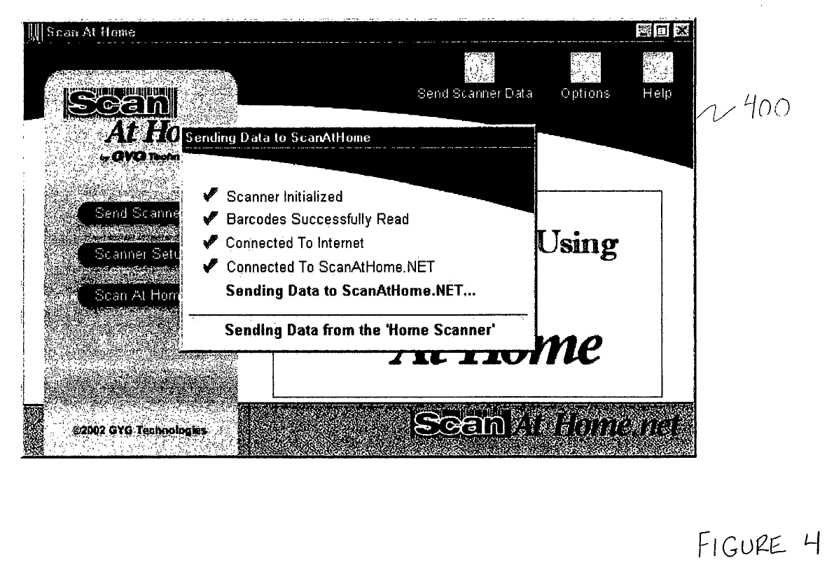

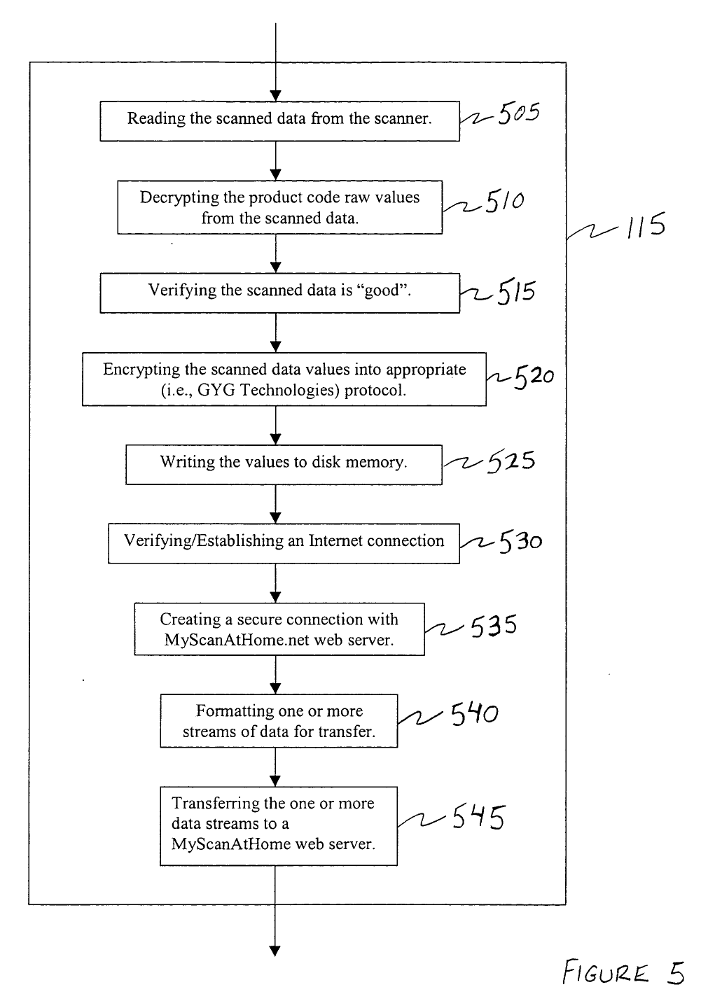

As previously mentioned, the client application utilized preferably comprises the SAH Application. The SAH Application is launched on the consumer side, and is either done so manually, e.g., by the consumer clicking a ‘Send Scanner Data’ icon 305 generated by the SAH Application and displayed on the processing device screen (see screen shot 300 shown in FIG. 3), or automatically when the processing device having accessibility to the network becomes aware of the scanner being connected. Subsequent to its launch, the SAH Application performs a variety of tasks (see screen shot 400 shown in FIG. 4). The tasks preferably performed by the SAH Application subsequent to its launch (in step 115 of FIG. 1) are depicted in FIG. 5. One task, referenced as 505, includes reading the scanned data from the scanner. Subsequent to this task, other respective tasks 510 and 515 involve decrypting the product code raw values and verifying the data. Upon successful verification of “good” data, tasks 520 and 525 include encrypting the scanned data values into appropriate (i.e., GYG Technologies) protocol and then writing the values to disk memory, respectively. The data being written to disk serves only a precautionary purpose, alleviating the possible loss of data during instances of power outages, computer failures or general outages during the period between when the data is extrapolated from the scanning device and when the data is successfully further transferred.

Other tasks 530 and 535 of the SAH Application include verifying/establishing a network connection, and creating a secure connection with MyScanAtHome.net web server, respectively. In certain embodiments, the network connection is an inter-network connection, preferably a public network or the Internet. For illustrative purposes, the network connection will be referred to as a connection to the Internet, however, this is not with the intention to limit the invention as such. Therefore, the processing device with the network access is connected to the Internet.

In certain embodiments, the SAH Application will verify the processing device is connected via dial-up Internet connection, local area network (LAN) connection, WAN (Wide Area Network) connection, wireless Internet connections (PDAs, Cell phones, wireless pc cards for laptops etc.), or proxy Internet connection. If no Internet connection is found, the SAH Application will search for a default dial-up Internet connection. If found, the SAH Application will preferably initiate a dial-up connection process and automatically connect the data transmitting processing device to the Internet. In certain embodiments, the SAH Application connects to the MyScanAtHome web server via http protocol. However, the connection can be performed via https protocol as well. In certain preferable embodiments, the connection process is done unbeknownst to the consumer.

Another task 545 of the SAH Application includes transferring data to the MyScanAtHome web server. This transfer is preferably completed using TCP/IP and like Internet protocols. Prior to transferring the newly scanned information, the SAH Application identifies any previously scanned information, which had not yet been successfully transferred to the servers, as data may not have been transferred if a transfer had previously failed. Subsequently, one or more streams of data is formatted for transfer, referenced as task 540. Preferably, these data streams are formatted in XML. In certain preferable embodiments, the one or more streams of data at least include the scanned data, the customer differentiation data (e.g., CID), and SAH Application parameters. The CID is used to enable unique customer identification recognition when transferring the data to the MyScanAtHome server, while the SAH Application parameters indicate whether the scanned data should be further transferred and whether the SAH Application should be further updated. Preferably, the SAH Application posts the one or more data streams to the MyScanAtHome web server via HTTP protocol and awaits a server reply message code.

Referring back to FIG. 1, in step 120, a server application receives and interprets the one or more streams of data transferred by the SAH Application. In certain preferable embodiments, the server application comprises MyScanAtHome (MSAH) Application code created by GYG Technologies Inc. Based on its interpretation of the data streams, the server application can react in one of three ways. If the SAH Application parameters indicate that the scanned data is not specific to or configured for any of one or more eRetailers, the scanned data is written to the MyScanAtHome server database, as indicated in step 125. In turn, the scanned data may only be transferred manually from MyScanAtHome.net, with the data being routed by the consumer from the MyScanAtHome database to one or more of the retailer internet sites, as represented by step 130 and referenced as a Manual-Transfer. Alternatively, if the SAH Application parameters indicate that the scanned data is specific to or configured for one or more eRetailers, the data and the CID, as well as any other information required by the retailer for identification, are automatically transferred from the MyScanAtHome server to one or more internet sites of the one or more eRetailers, as represented by step 135 and referenced as an Auto-Transfer. Finally, the SAH Application parameters may indicate that the scanned data is comprised of some data that is not eRetailer specific and some data that is eRetailer-specific. In this case, the scanned data is divided, as referenced in step 140. The scanned data that is not eRetailer-specific is written to the MyScanAtHome server database, indicated in step 145. Further, the scanned data may only be transferred manually by the consumer as detailed above in step 130. In contrast, the scanned data that is eRetailer-specific is automatically transferred, along with the CID (and any other required information by the retailer), from the MyScanAtHome server to one or more internet sites of the one or more eRetailers, as detailed in step 150. This scenario, involving multiple varieties of data, described in step 140, is referenced as a Manual/Auto-Transfer.

In referring to scanned data that is specific to or configured for one or more eRetailers, it is not intended to suggest that the products originally scanned are only sold by these specific retailers. In order to determine if the scanned data is indeed eRetailer-specific, the data stream is compared to a eRetailer's item file stored in a MyScanAtHome server database. If a match is made between the data stream and the item file, the scanned data is deemed to be specific to that eRetailer.

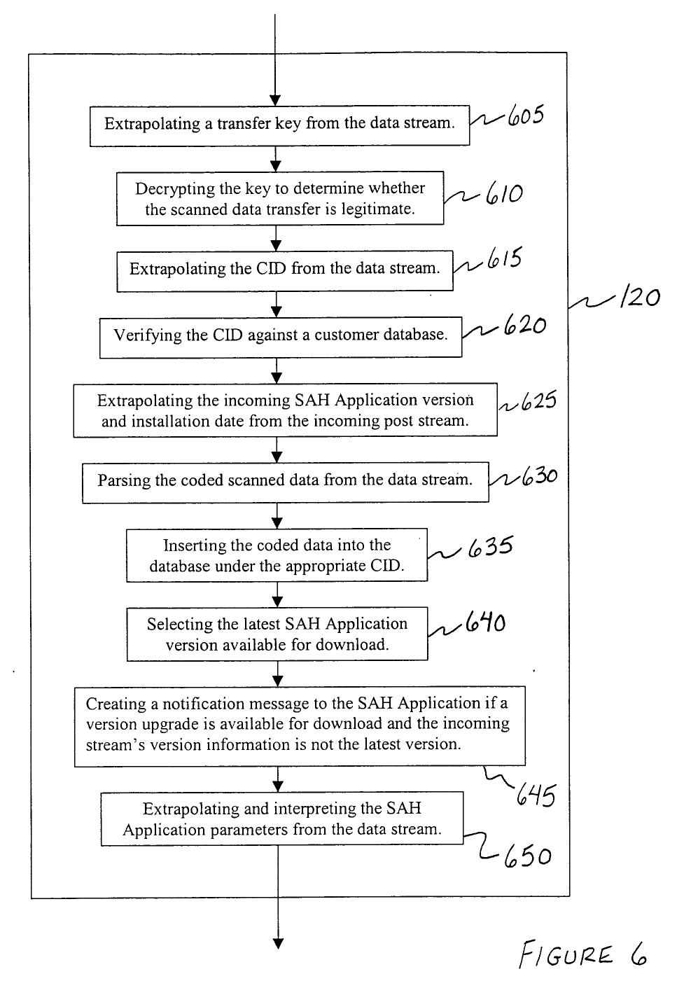

As previously mentioned, the server application utilized preferably comprises the MSAH Application. The MSAH Application is in place for direct communication with the SAH Application software. The main function of the MSAH Application is to receive the scanned data from the SAH Application and subsequently log the data into the MyScanAtHome server database. While step 120 (in FIG. 1) references the MSAH Application interpreting the one or more streams of data, there are a number of additional tasks preferably performed by the SAH Application included in step 120 subsequent to receiving the scanned data. These additional tasks are depicted in FIG. 6 and described below.

Upon receipt of the stream of data, initial tasks 605 and 610 of the MSAH Application include extrapolating a transfer key from the data stream and decrypting the key to determine whether the scanned data transfer is legitimate, respectively. Subsequent tasks 615 and 620 include respectively extrapolating the CID from the data stream and verifying the CID against a customer database to make sure the consumer is valid, in good status, i.e., active, and is “able” to transmit scanned data to/through the MyScanAtHome servers. Another task 625 involves extrapolating the incoming SAH Application parameters (e.g., version and installation date) from the incoming data stream. Additionally, tasks 630 and 635 include parsing the coded scanned data from the data stream and inserting the coded data into the database under the appropriate CID, respectively. Other tasks 640 and 645 would involve selecting the latest SAH Application version available for download from a database table, and creating a notification message within a return message to the SAH Application if a version upgrade is available for download and the incoming stream's version information is not the latest version, respectively. Finally, one task 650 would involve extrapolating and interpreting the SAH Application information from the data stream.

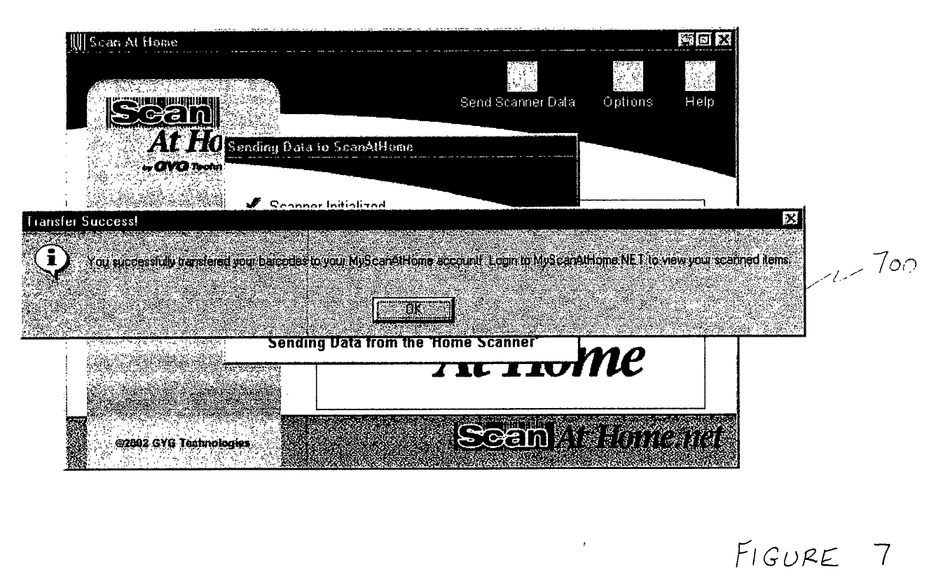

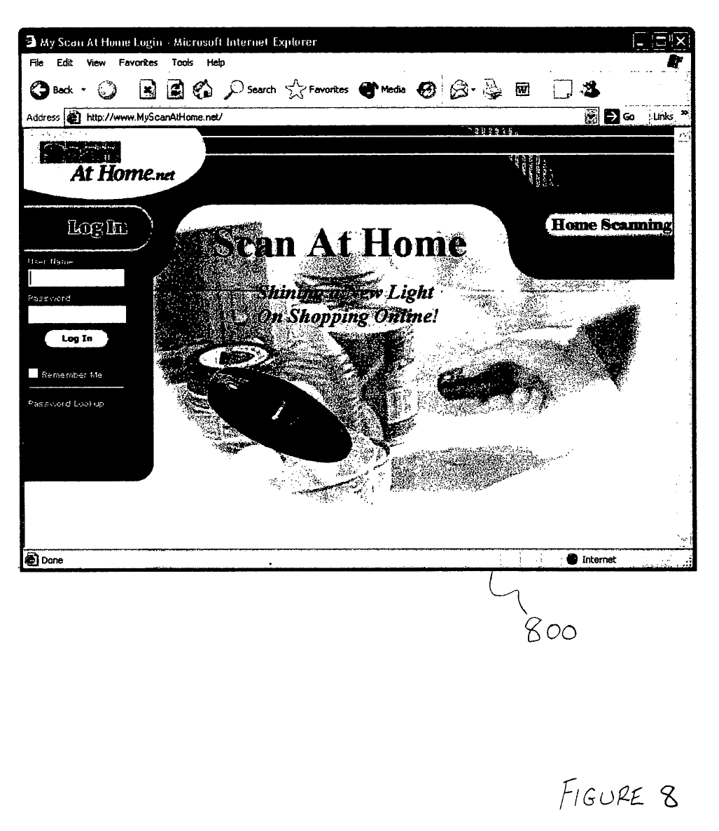

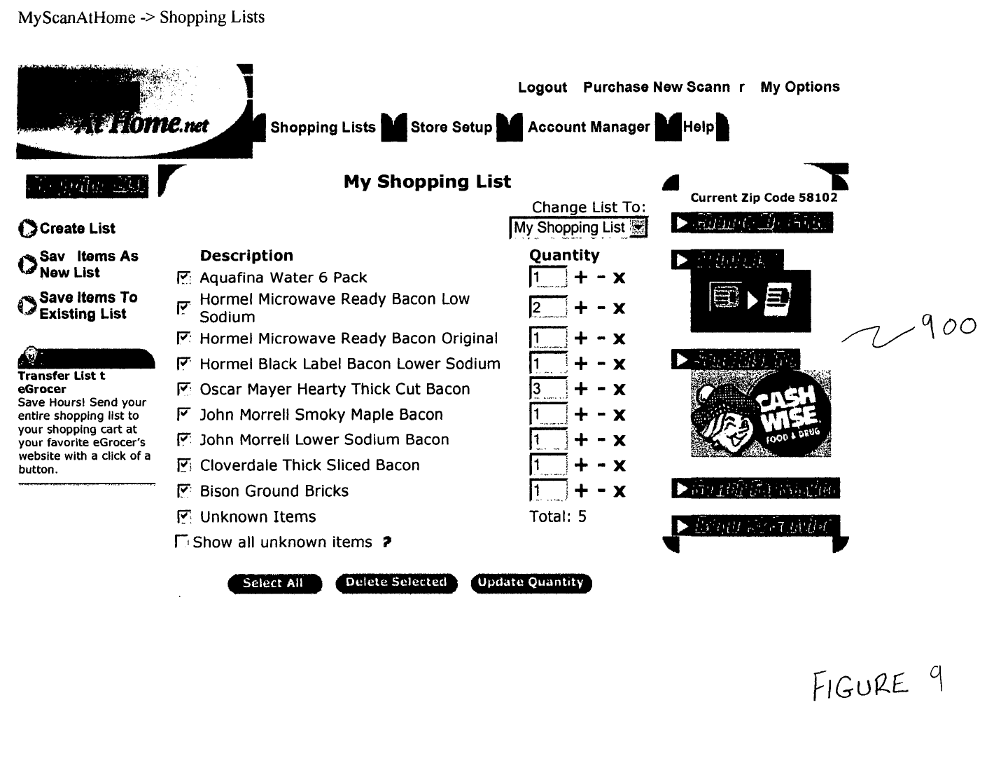

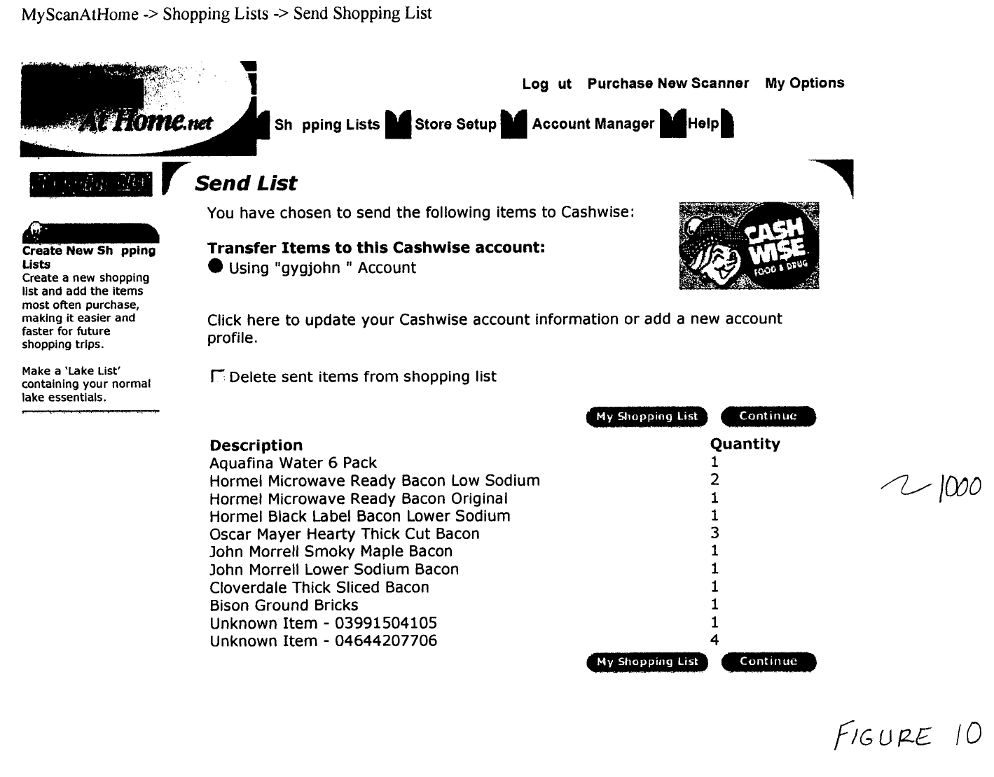

Referring back to FIG. 1, in step 125, the Manual-Transfer occurs after the SAH Application has successfully transferred the stream of data to the MyScanAtHome server. The MSAH Application has interpreted the data as not being specific to or configured for any of one or more eRetailers. In turn, the data is written to the MyScanAtHome server database and inserted into a MyScanAtHome shopping list for the consumer (via the CID). Following the transfer, the MSAH Application reports back to the SAH Application, indicating whether the transfer was successful (see screen shot 700 shown in FIG. 7). If the transfer was successful, the SAH Application opens the consumer's default web browser and directs the consumer to the MyScanAtHome website, generally to the log-in screen (see screen shot 800 shown in FIG. 8). When the consumer logs into MyScanAtHome.net using a unique id and password, access is granted such that the consumer can view the recently transferred and previously scanned data (see screen shot 900 shown in FIG. 9) including corresponding item descriptions and aggregated quantities (multiple quantities of a single item facilitated through repeated scans of the same barcode). In certain preferable embodiments, the consumer is prompted to initially select items which they wish to transfer from the recently scanned shopping list or other previously scanned shopping lists. Subsequently, the consumer selects one or more eRetailers to have the selected items transferred (see screen shot 1000 shown in FIG. 10).

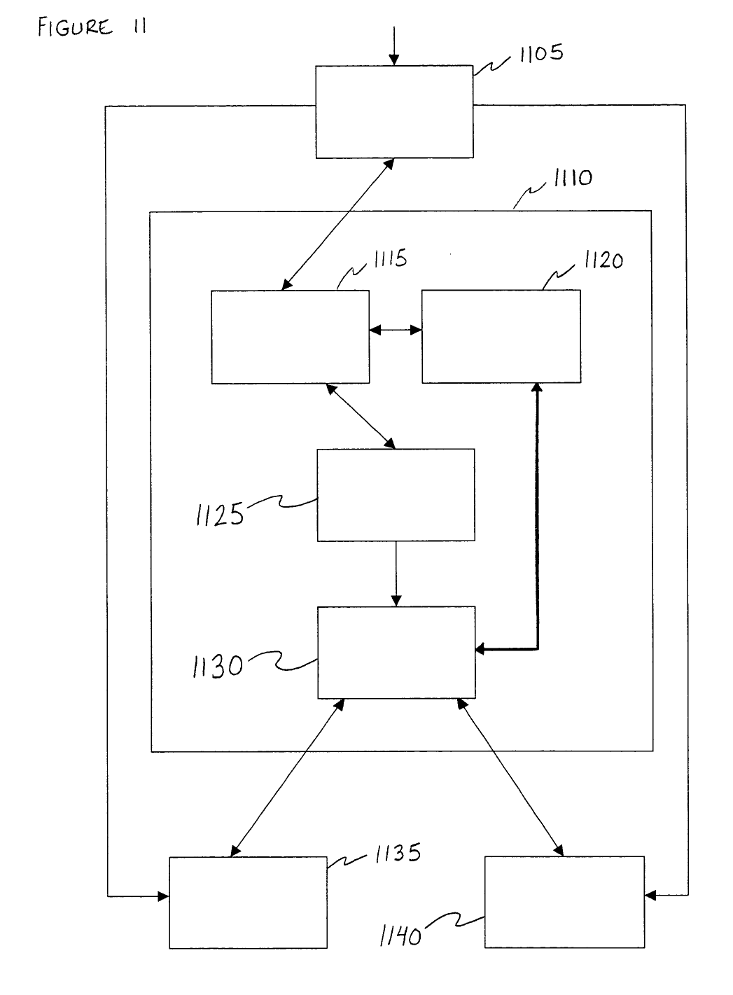

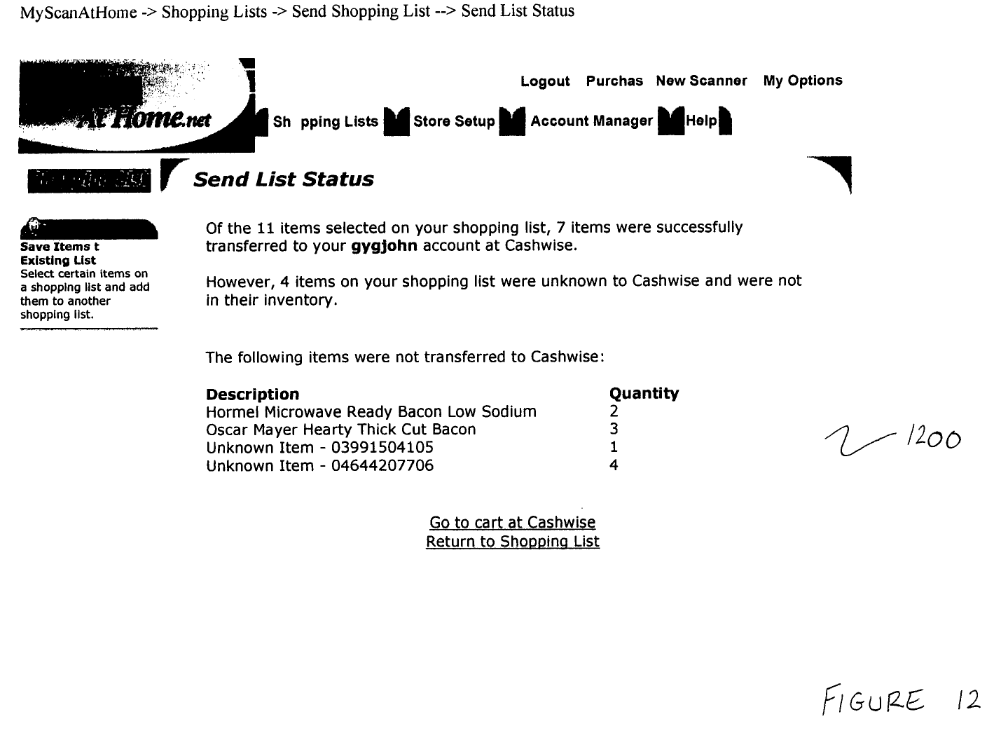

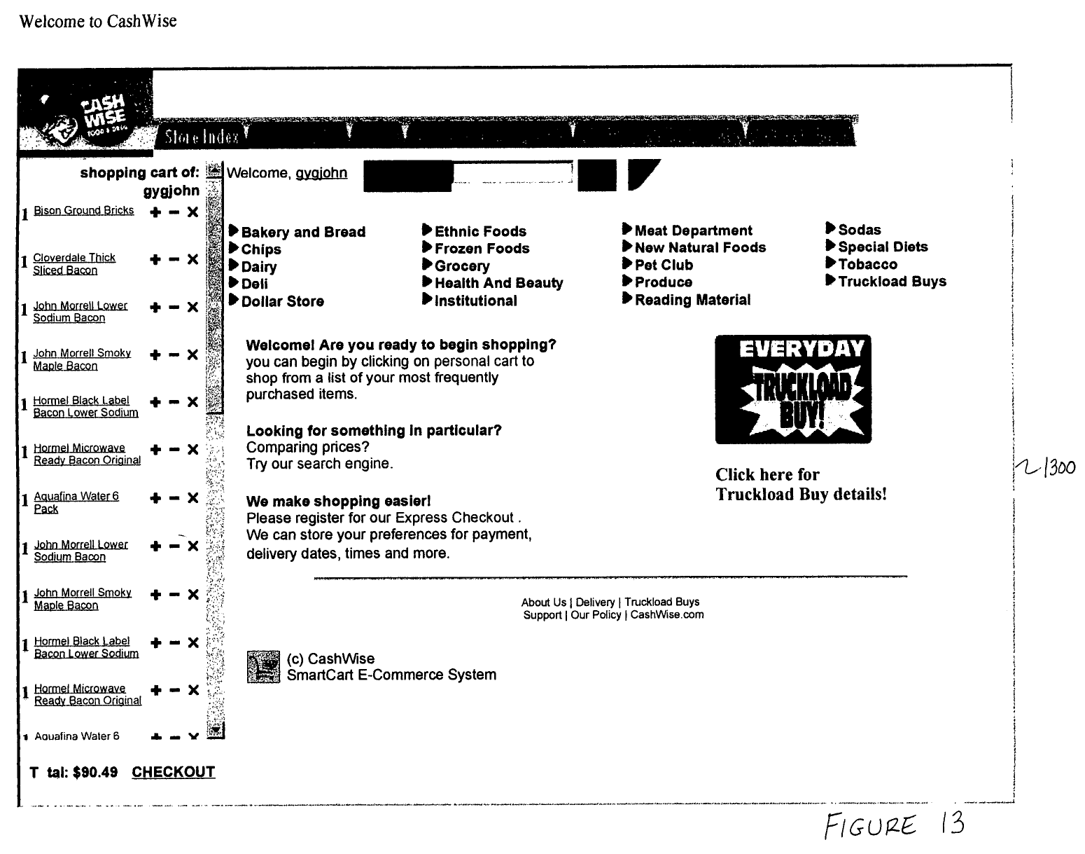

As shown in FIG. 11, a background, server application 1125 is alerted via the MSAH Application 1115, and in turn, the background, server application 1125 triggers a server controller 1130. As a consequence of this triggering, the items are transferred to the server controller 1130, which performs an unseen transfer of the item/quantity data to the chosen eRetailer websites 1135 and 1140, inserting one or more of the items into the consumer's shopping cart on each chosen eRetailer site (not shown). The background, server application 1125 then reports the transfer status back to the consumer via the MSAH and SAH Applications 1115 and 1105, respectively (see screen shot 1200 shown in FIG. 12). In turn, the consumer is directed to the chosen eRetailer sites 1135 and 1140, wherein each site, the recently transferred data in the shopping cart can be viewed, shopping cart contents may be added/subtracted/modified, and the consumer can finalize the purchase process according to that particular eRetailer's eCommerce purchase finalization needs (see screen shot 1300 shown in FIG. 13). It should be appreciated that while two websites 1135 and 1140 are depicted herein, certain other preferable embodiments may only function with one retailer website, while other preferable embodiments may function with more than two retailer websites. While two websites are shown in FIG. 11, the number of retailer websites that the system can function with is not limited as such, and is contemplated herein for exemplary purposes only.

Alternatively, the consumer may simply print one or more MyScanAtHome shopping lists that they can take with them to the store. In certain preferable embodiments, the consumer would be able to sort their shopping list via a local supermarket's aisle layout, as well as print corresponding product images of the scanned product tags. Additionally, the coded data could be recompiled for each scanned item so that the product tag image is recreated. Therefore, consumers could print shopping lists with corresponding item product tags as well.

Referring back to FIG. 1, in step 135, the Auto-Transfer occurs after the SAH Application has successfully transferred the stream of data to the MyScanAtHome server. The MSAH Application has interpreted the data as being specific to one or more eRetailers. The Auto-Transfer is initiated on the consumer side since the SAH Application software has been specially-configured for one or more particular retailers. In being specially-configured, the application software is customized, branded and recompiled for the one or more particular retailers. This configuration also necessitates an acceptance from each of these particular retailers that all items existing within their online database which have been scanned by the customer may be automatically transferred to that consumer's shopping cart on their eRetail website without any other consumer intervention.

As previously described in reference to FIG. 11, the background, server application 1125 is alerted via the MSAH Application 1115, and in turn, the background, server application 1125 triggers the server controller 1130. As a consequence of this triggering, the items are transferred to the server controller 1130, which performs an unseen transfer of the item/quantity data to the chosen eRetailer websites 1135 and 1140, inserting one or more of the items into the consumer's shopping cart on each chosen eRetailer site (not shown). The background, server application 1125 then reports the transfer status back to the consumer via the MSAH and SAH Applications 1115 and 1105, respectively (see screen shot 1200 shown in FIG. 17). The SAH Application 1105 then opens the consumer's default web browser and directs them to one or more of the retailer's websites 1135 and 1140, where one or more of the scanned items appear. For cases in which the retailer's eCommerce program does not require the consumer to finalize the purchase, the SAH Application 1105 simply reports back to the consumer the status of the transfer once the data transfer to the one or more retailer's websites 1135 and 1140 is complete. Once again, while two websites are shown in FIG. 11, the number of retailer websites that the system can function with is not limited as such, and is contemplated herein for exemplary purposes only.

Referring back to FIG. 1, in step 140, the Manual/Auto-Transfer occurs after the SAH Application has successfully transferred the XML stream of data to the MyScanAtHome server, and after the MSAH Application has interpreted the data as being comprised of some data that is not eRetailer-specific, and some data that is eRetailer specific. As such, the data is divided accordingly. The data that is not eRetailer-specific is similarly stored and transferred following steps 145 and 130, which are similar in content to steps 125 and 130, respectively, which are detailed above. The data that is specific to one or more eRetailers is transferred following step 150, which is similar in content to step 135, which is described above.

The background, server application 1125 mentioned above and depicted in FIG. 11 is a non-visual, compiled machine code server object which receives calls from the MSAH Application 1115. When a transfer trigger is received, the background, server application 1125 verifies that the server controller 1130 is up and running (if not—the background application 1125 will launch the controller 1130) and initiates commands to the controller 1130, which actually performs the data transfer from the MyScanAtHome server 1110 to the one or more selected eRetailers, e.g., 1135 and 1140.

The server controller 1130 mentioned above and depicted in FIG. 11 is compiled machine code designed to be a threaded application. In certain preferable embodiments, an internal algorithm is utilized to constantly calculate the current server sessions and proportionally maintain an open thread pool. Typically, the controller 1130 receives its transfer instructions via semaphore, originating from the MyScanAtHome website when a user attempts to transfer items to an eRetailer. Once the controller 1130 receives transfer commands, the database is queried. Upon successful query, the controller 1130 initiates a thread ID for every customer record retrieved from the database table. Typically only one result is returned from the database, however, it is possible that 10 customers could initiate the command at the exact same moment in time, which would result in the controller 1130 simply retrieving 10 records with the single query. Preferably, the controller 1130 will handle up to one thousand simultaneous threads. In so doing, the controller 1130 can transfer up to one thousand simultaneous customer transactions to specific eRetailers.

Each customer in queue is then spun off on its corresponding thread, and handed its transfer instructions. According to the transfer instructions, the controller 1130 then connects to the corresponding eRetailers 1135 or 1140, and transfers the scanned data along with the CID, and secure server tag id (to assure the eRetailer the data is from MyScanAtHome). The controller 1130 waits for a status message sent back from the eRetailer, which in turn logs the message and updates when complete.

The home shopping system of the present invention thus allows a consumer to scan product tags and have the scanned information transferred to a central server via a network, where the consumer can either manually or automatically transfer the information therefrom to one or more desired retailer network sites. Using the embodiments of the apparatus and methods described herein, the present invention provides an effective manner of doing such. While a preferred embodiment of the present invention has been described, it should be understood that various changes, adaptations, and modifications may be made therein without departing from the spirit of the invention and the scope of the appended claims.

What is claimed is:

1. A shopping system comprising:
a scanner adapted to scan one or more product tags;
a processing device accessible to a network, the processing device operatively coupled to the scanner;
a client application installed on the processing device, the client application adapted to read scanned data from the scanner and to transfer the data over the network;
a server on the network adapted to receive the transferred data; and
a server application configured to run on the server, the server application adapted to route the transferred data to one or more retailer network sites.

2. The system of claim 1, wherein the scanner comprises a wireless and handheld mechanism.

3. The system of claim 2, wherein the scanner is adapted to be removable from a downloading cradle that is operatively coupled to the processing device.

4. The system of claim 1, wherein the scanner is adapted to decode each of the scanned product tags and to store the values within memory.

5. The system of claim 1, wherein one or more of the product tags comprise barcodes.

6. The system of claim 1, wherein the processing device comprises a personal computer.

7. The system of claim 1, wherein the processing device comprises a cell phone.

8. The system of claim 1, wherein the processing device comprises a personal digital assistant.

9. The system of claim 1, wherein the network comprises an inter-network.

10. The system of claim 9, wherein the network comprises a public network.

11. The system of claim 9, wherein the network comprises the Internet.

12. The system of claim 1, wherein the server comprises a website.

13. The system of claim 1, wherein the server further comprises a database adapted for storing the transferred data.

14. The system of claim 1, wherein the client application is adapted to be activated manually by a consumer through the processing device.

15. The system of claim 1, wherein the client application is adapted to be activated automatically through the coupling of the scanner to the processing device.

16. The system of claim 1, wherein the client application is adapted to create a secure network connection between the processing device and the server.

17. The system of claim 1, wherein the client application is adapted to create one or more streams of data to transfer.

18. The system of claim 17, wherein the streams of data are formatted in XML.

19. The system of claim 17, wherein each of the one or more streams of data include the scanned data, customer differentiation data, and client application parameters.

20. The system of claim 19, wherein the server application is adapted to receive and interpret the one or more streams of data.

21. The system of claim 20, wherein the server application is adapted to determine if the scanned data is specific to the one or more retailers based on the client application parameters.

22. The system of claim 21, wherein the server application is adapted to store the one or more streams of data in a database configured to the server if the scanned data is not specific to one or more retailers.

23. The system of claim 21, wherein the server application is adapted to route the one or more streams of data to one or more retailer network sites if the scanned data is specific to the one or more retailers.

24. The system of claim 17, further comprising a server controller configured to run on the server and adapted to facilitate the transfer of the one or more streams of data to the one or more retailer network sites.

25. A shopping system comprising:
means for reading and storing one or more product tags;
a processing device accessible to a network, the processing device operatively coupled to the means;
a client application installed on the processing device, the client application adapted to read the stored data and to transfer the data over the network;
a server on the network adapted to receive the transferred data; and
a server application configured to run on the server, the server application adapted to route the transferred data to one or more retailer network sites.

26. The system of claim 25, wherein the means comprises a scanner.

27. A shopping system comprising:
means for reading and storing one or more product tags, the means being accessible to a network;
a client application installed to the means, the client application adapted to read the stored data and to transfer the data over the network;
a server on the network adapted to receive the transferred data; and
a server application configured to run on the server, the server application adapted to route the transferred data to one or more retailer network sites.

28. The system of claim 27, wherein the means comprises a scanner.

29. A method of shopping comprising:
scanning one or more product tags using a scanner;
coupling the scanner to a processing device accessible to a network;
transferring the scanned data to a server over the network using a client application; and
transferring the scanned data to one or more retailer network sites from the server using a server application.

30. The method of claim 29, wherein the step of scanning the one or more product tags further comprises steps of decoding each of the scanned product tags and storing the values within memory.

31. The method of claim 29, wherein the step of coupling the scanner to a processing device further comprises a step of connecting the scanner to a downloading cradle that is coupled to the processing device.

32. The method of claim 29, wherein the step of transferring the scanned data to the server further comprises a step of activating the client application manually by a consumer through the processing device.

33. The method of claim 29, wherein the step of transferring the scanned data to the server further comprises a step of creating a secure network connection between the processing device and the server.

34. The method of claim 29, wherein the step of transferring the scanned data to the server further comprises a step of creating one or more streams of data to transfer.

35. The method of claim 34, wherein the step of creating one or more streams of data further comprises a step of including the scanned data, customer differentiation data, and client application parameters in each of the one or more streams of data.

36. The method of claim 35, wherein the step of transferring the scanned data to one or more retailer network sites further comprises a step of interpreting the one or more streams of data.

37. The method of claim 36, wherein the step of transferring the scanned data to one or more retailer network sites further comprises a step of determining if the scanned data is specific to the one or more retailers based on the client application parameters.

38. The method of claim 37, wherein the step of transferring the scanned data to one or more retailer network sites further comprises a step of storing the one or more streams of data in a database configured to the server if the scanned data is not specific to the one or more retailers.

39. The method of claim 37, wherein the step of transferring the scanned data to one or more retailer network sites further comprises a step of routing the one or more streams of data to the one or more retailer network sites if the scanned data is specific to the one or more retailers.
